(19) United States
(12) Patent Application Publication
(10) Pub. No.: US 2009/0122144 A1
(43) Pub. Date: May 14, 2009

(54) Method for detecting events at a secured location

(76) Inventors: Joel Pat Latham, Arlington, TX (US); Steven Wayne Belden, Lucas, TX (US); Greig Stovall Latham, Lucas, TX (US); Barry Arthur Hall, Bowie, TX (US); Michael A. Ramsey, Double Oak, TX (US); Matt Kyle, Garland, TX (US)

Correspondence Address: Steven Thrasher, 391 Sandhill Dr., Richardson, TX, 75080, US

(21) Appl. No.: 12/011,538

(22) Filed: Jan. 26, 2008

Related U.S. Application Data
(60) Provisional application No. 61/002,975, filed on Nov. 14, 2007.

(51) Int. Cl. H04N 7/18

(52) U.S. Cl. 348/155; 348/E07.085

(57) ABSTRACT

A method for detecting events/activities at a secured location in which the security method may include an operator and/or determination application for supervising the location, and a transmission network for transceiving data indicative of determined activities of the secured location, wherein the determination application and the operator can initiate a deter device in response to adverse activities. The determination application of the security method may include an intelligence system for distinguishing between normal and adverse conditions. The method may also include an application for the transfer of activity data to a storage device in which operator(s) may access the stored data.

### CROSS REFERENCE TO RELATED APPLICATIONS

This application is related to two copending applications filed on the same day as the present application, the contents of both being incorporated herein by reference. One is entitled, “A Detecting, Detering Security System”, Ser. No. ______, and assigned to the same assignee as the present application. The second related application entitled, “A Security System and Network”, Ser. No. ______, and also assigned to the same assignee as the present application

### TECHNICAL FIELD

The present invention relates to security methods and, more specifically, security methods for use in securing defined locations.

### BACKGROUND OF THE INVENTION

Security systems are known in the art and a typical security system is located for the purpose of securing a defined area and discouraging unwanted and illegal activities such as trespassing, theft, sabotage. The defined area that is secured by the security system will usually comprise a closed area, such as a specified room(s) within a building, or an entire building or house.

All security systems and methods have certain basic elements in common. All include one or more sensors that are used to sense an entry event or other activity that could be viewed as an unauthorized trespassing, theft, sabotage. The sensors are coupled, usually with electrical wires, to a central control. When an entry or other activity is detected by the sensor, a signal is sent to the central control, which generates an alarm signal. The alarm signal may be used locally to sound an audible alarm or to inform local security personnel. The alarm signal may also be used to signal a remote location, such as a police station.

More sophisticated security systems and methods supplement this basic security system with additional sensors (e.g., that sense the opening of the security box itself, the presence of motion within the secured area, and detection of smoke or fire). Such systems and methods may also include backup battery protection and remote paging capabilities, but all lack to ability to use sensors to distinguish and/or learn to distinguish between a false detection and an actual alarm condition. They also lack sufficient ability to deter trespassing, theft, and/or sabotage by individuals.

### SUMMARY OF THE INVENTION

In one aspect of the present invention, a method is provided for monitoring a secured location. The method includes capturing events detected at the secured location by sensory devices, identifying a first condition of the secured location in response to receiving events data captured by the sensory devices, identifying a second condition of the secured location in response to receiving further event data capture by the sensory devices, comparing the first and second conditions to determine if an abnormal condition exist, and conditionally initiating a deter event local to the secured location responsive to a determined abnormal condition at the secured location.

In another aspect of the present invention, a method is provided for monitoring events at a defined outdoor location, the outdoor location including a security event detection system which includes a video surveillance device configured to provide images of surrounding objects and further configurable to detect security events sensed from other sensing devices, the outdoor location also including deter devices, the deter devices including at least one of a plurality of devices selected from a group comprising a two-way audio device, a strobe light, a siren, and a spray emitter, and wherein the two-way audio device enables two-way conversation between an operator and anyone present in the outdoor location. The method includes capturing events detected at the secured location by sensory devices, identifying a first condition of the secured location in response to the captured detected events, identifying a second condition of the secured location in response to receiving further captured events detected at the secured location, comparing the first and second conditions to determine if an abnormal condition exist, and notifying an operator for supervising the secured location responsive to a determined abnormal condition.

In another aspect of the present invention, a machine-readable medium is provided in which instructions thereon cause a computing device to perform a method of detecting and deterring defined activities at a secured location. The method including capturing events detected at the secured location by sensory devices, receiving event data captured by the sensory devices, identifying a first condition of the secured location in response to receiving events data captured by the sensory devices, identifying a second condition of the secured location in response to receiving further event data capture by the sensory devices, comparing the first and second conditions to determine if an abnormal condition exist, and conditionally initiating a deter event local to the secured location responsive to a determined abnormal condition at the secured location.

In another aspect, the present invention provides a security system for monitoring an area from intruders. The security system includes an enclosure for weather protection of the intelligent system, a detector device, and a deter device. The security system also includes at least one power source for providing power to the security system and a programmable determination device mounted within the enclosure, wherein the programmable determination device is for activating a deter measure in response to a detection signal from the detector.

In another aspect, the present invention provides a security system for monitoring an area from intruders. The security system includes an enclosure for weather protection of the intelligent system, a detector device, and a deter device, wherein the enclosure, the detector device, and the deter device can be mounted on a rigid structure within the monitored area. The security system also includes a battery and a programmable determination device mounted within the enclosure, wherein the programmable determination device is for activating a deter measure in response to a detection signal from the detector.

In another aspect, the present invention provides a security system for monitoring an area from intruders. The security system includes an enclosure for weather protection of the intelligent system, a detector device, and a deter device, wherein the enclosure, the detector device, and the deter device can be mounted on a rigid structure within the monitored area. The security system also includes a battery and a programmable determination device mounted within the enclosure, wherein the programmable determination device is for activating a deter measure in response to a detection signal from the detector. Further, the programmable determination device is an object recognition device capable of recognizing objects within the monitored area in a first condition and in a second condition.

In another aspect, the present invention provides a security system including a plurality of power sources for providing electrical power to the security system, a security event detection system including a visual detection device for detecting a security event and responsive thereto generating data indicative of the security event, a programmable determination device for receiving the security event data and initiating deter measures, a deter device actuated by the programmable determination device upon a determined security event, and a data collection system configured to collect and store security event data.

In another aspect, the present invention provides a portable security system for protection of property within an outdoor area monitored for human interaction, the security system including a security event detection system including a video surveillance device configured to provide images of surrounding objects and further configurable to detect security events sensed from other sensing devices, a programmable determination device for receiving the object images and sensed security event data and responsive thereto determining if an alarm condition is present for initiating a deter measure, wherein the programmable determination device is capable of object condition recognition such that objects within the monitored outdoor area are first recorded in a first condition and a security event is initiated if any one of the objects are determined to be in a condition different from the first condition, wherein the conditions are provided via a further scan provided from the video surveillance device, and a deter device actuated by the programmable determination device upon a determined alarm condition, wherein the deter device in at least one of a plurality of detection devices selected from a group comprising a two-way audio device, a strobe light, a siren, and a spray emitter, and wherein the two-way audio device enables an monitor operator to converse with anyone present in the monitored area, wherein the security event detection system and the deter device are attached to a rigid structure and the programmable determination device is contained in a weather proof enclosure which is also attached to the rigid structure.

In another aspect, the present invention provides a security system for monitoring an area and having a security detection system local to the monitoring area for detecting a security event, the security detection system including a visual detection device for detecting a security event and, responsive to detecting a security event, generating data indicative of the security event, a deter device, and an input/output communication device coupled with the security detection system and the deter device for transceiving data, security system including an operator for supervising the monitored area, and a wireless communication system for transceiving the generated data received from the input/output communication device to the operator, wherein the operator can determine if the deter device is to be actuated based on the generated data, and wherein the operator can be onsite to the monitored area and can be remote to the monitored area.

In another aspect, the present invention provides a portable security system for protection of property within a plurality of outdoor areas, the portable security system including a security event detection system for each of the plurality of outdoor areas and each security event detection system including a video surveillance device configured to provide images of surrounding objects and further configurable to detect security events sensed from other sensing devices, the portable security system also including deter devices for each of the plurality of outdoor areas, the deter devices including at least one of a plurality of deter devices selected from a group comprising a two-way audio device, a strobe light, a siren, and a spray emitter, and wherein the two-way audio device enables two-way conversation with anyone present in the monitored areas, and the portable security system also including an input/output communication device for each of the outdoor areas coupled with respective security detection systems and the deter devices for transceiving data, the detection devices generate data indicative of detection events which are transmitted to the input/output communication device, the security event detection systems and the deter devices are attached to a rigid mobile structure in the outdoor areas, the portable security system including an operator for supervising the plurality of outdoor areas, and a wireless communication system for transceiving the data received from and to the plurality of input/output communication devices to be received by the operator, wherein the operator can determine if a deter device is remote to the outdoor areas.

### BRIEF DESCRIPTION OF THE DRAWINGS

FIG. 1 illustrates a security system with system components in accordance with an embodiment of the present invention;

FIG. 2 illustrates the security system components and other components in accordance with an embodiment of the present invention;

FIG. 3 illustrates the security system components mounted on a rigid structure in accordance with an embodiment of the present invention;

FIG. 4 illustrates the security system in communication with near/onsite users and a remote operator in accordance with an embodiment of the present invention;

FIG. 5 illustrates multiple security systems in communication with to a remote operator in accordance with an embodiment of the present invention;

FIG. 6 there is illustrated a methodology for monitoring a secured location in accordance with an embodiment of the present invention; and

FIG. 7 there is shown a method for monitoring a secured location in accordance with an embodiment of the present invention.

### DETAILED DESCRIPTION

Whether involved in site preparation, drilling, extraction, or cleanup, a company's financial commitment is immense. Each step represents an investment of hundreds of thousands, if not millions of dollars—an investment worth protecting. The present invention is an advanced system which can be self-contained, self-powered analytics system that protects investments.

The present invention offers real-time event detection. One can monitor the exact location of choice—large or small—and can designate specific activities to detect. Once designated, the specific area to be monitored, the present invention's video/cameras can capture activity occurring in the monitored area. These images are transferred to the present invention's Intelligence system (IS) 14 for real-time analysis and the IC can define what constitutes a security event for the location being monitored. So whether concerned about intruders, theft, sabotage, or unusual changes in the area monitored, the present invention's security system can detect them automatically and accurately. When an event occurs, the present inventions input/output can send alerts immediately using methods such as email, text message, or a phone call using wireless or hard wire.

With the use of specialized sensors, the present invention can also be programmed to detect and alert about events, such as equipment failure, movements or lack of movement, change in temperature or pressure, change in sound levels, glass breakage, and detection of smoke.

The present invention also can deter events before they occur, discouraging unwanted and/or illegal activities such as trespassing, theft, and sabotage. For example, by broadcasting a customized, audible warning to anyone detected in the monitored zone, intruders are sure to know they are being watched. Additionally, the present invention can include remote two-way conversation at the security site, which allows two-way conversation with a remote monitor and anyone detected in the monitored zone.

Once an image, audio, and other data has been analyzed, it can be transferred to a to a storage device such as a Digital Video Recorder (DVR), or similar device, where it is captured in an easily searchable format. Event data captured can be used for training the present system of normal/abnormal detection events, for documentation of practice, or as evidence. Normal activity can be archived at lower rates to conserve storage space and bandwidth. At regular intervals, event data can be transferred wirelessly to a secure datacenter for storage. Once in the datacenter, the data can be archived in a non-erasable, non-modifiable format ensuring the security and preservation of the original data.

Utilizing pre-arranged access to the present invention's security system a remote monitor can access the security system or data for review and use. Additionally, copies of any archived video, audio, or other data can be provided on CD/DVD or archive tape.

In addition, the present invention can provide Video Analytics capability for routine monitoring for management purposes. This live video stream can be available 24 hours a day and allows a remote monitor to observe daily activities such as: Contractors on site, delivery of materials and supplies, employee activities, engineering management, and regular inspection.

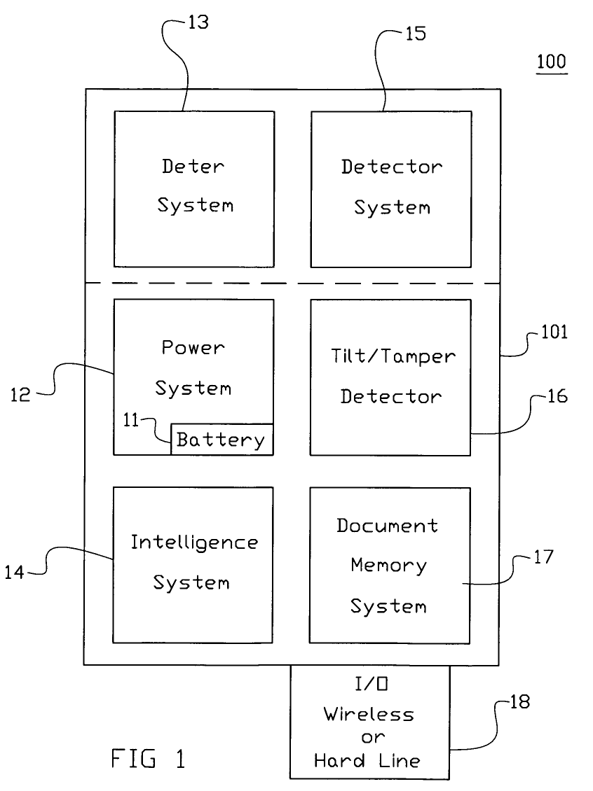

Now referring to FIG. 1, the security system 100 includes a power system 12 (including a battery 11), an Intelligence system 14, a detector system 15, a deter system 13, and an input/output 18. The security system 100 may also include a document memory system 17 and a tilt/tamper detector 16. The battery 11, the Intelligence system 14, the input/output 18, the document memory system 17, and the tilt/tamper detector 16 are contained in a weather proof control box 101 in one embodiment. The tilt/tamper detector 16 detects unauthorized movement or opening of the control box 101. Further, the detector system 15 and the deter system 13 are located outside the control box 101 but are in communication with components in the control box 101. Although the present security system 100 is preferred as an outdoor system, it could also be used to monitor indoor areas.

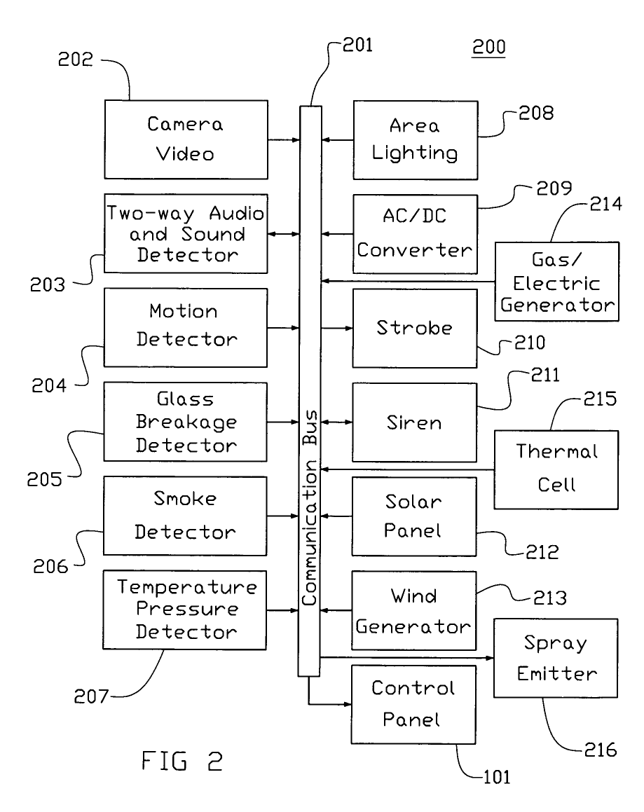

The Intelligence system 14 can include an object/image recognition system and a sound recognition system connectable with any of the sensory devices of the detector system 15 (shown in FIG. 2) and particularly to the video surveillance system 202 and sound detector 203. The Intelligence system 14 is configured to recognize objects and sounds disposed around the monitored area (e.g., equipment, supplies, tools, and other objects meant to be monitored against theft and sabotage and sounds such as dogs, etc.) and objects that may enter the monitored area (e.g., people, animals, motorized vehicles, etc.). The Intelligence system 14 receives video from the video surveillance system 202 or sound system 203 and analyzes the video and sound to determine if an object has left, been moved from, or entered the monitored area. The object and sound recognition system of the Intelligence system 14 can compare data representative of the detected objects or sounds with data representative of known objects or sound. Thus, the intelligence system 14 can recognize objects in a first condition and determine if there has been a condition in which the objects have been moved or removed from the monitor area. It further could determine if an object has entered the monitored area. In either case, the intelligence system 14 would initiate a deter measure and/or and may also initiate a communication with the document memory system 17 or may initiate a communication with a monitoring operator through the I/O device 18.

To enable the Intelligence system 14 it can include a computing device, such as a computer or a DSP for performing object recognition and alarm conditions analysis using information received from the sensing devices of FIG. 2. Further, it should be apparent that video from the video surveillance system 202 (and any other detector device, power source, or deter device) can be communicated to the control box 101 and to the object recognition system included within the Intelligence system 14 in a number of ways including a bus 201, hard wires, coaxial connector, or a wireless connection (for example by using a system utilizing the Bluetooth protocol, or integrated WiFi).

The video/camera surveillance system 202 can include multiple video/cameras which can be oriented in a fixed direction or the positioning can be controlled, for example, to adjust the pan-tilt-zoom of the video/camera and/or to position at various viewing angles using techniques known to those skilled in the art. When the video/camera surveillance system 202 captures images, the date is transmitted to either the intelligence system 14 or the document memory system 17 which can be a multimedia server such as a digital video recorder (DVR) or a computing device. The intelligence system 14 can also include a video encoder that encodes digitized video data that may be received from the video/camera surveillance system 202, and a management system that manages the video data for transmission to the document memory system 17 and/or the input/output 18 for transmission over a wireless network, for example, to remote users.

The input/output 18 can include a wireless interface and can be implemented using wireless technologies known to those skilled in the art such as the short-range radio technology known as Bluetooth or integrated WiFi, and various longer-range radio technologies such as cellular protocols.

Now referring to FIG. 2, the security system 200 includes the deter system 13, the detector system 15, the communication bus 201 and the control box 101. The detector system 15 can include any system for detecting and/or collecting security event data including, but not limited to, a motion detector 204 (which can include inferred technology), a video/camera surveillance system 202, a glass breakage detector 205, temperature and pressure detector 207, a smoke/fire detector 206, and an audio detector 203. When security events are detected, the detector system 15 generates event or alarm data indicative of the detected event for transmission to the intelligence system 14. The event or alarm data can include time stamps indicating a time of occurrence of the events as well as information describing the location of the event and the nature of the event or alarm.

The deter system 13 can include any system for deterring humans or animals from unauthorized activities within the monitored area and can include, but is not limited to, the two-way audio device 203, area lighting 208, a strobe 210, a siren 211, and a spray emitter 216. When security events are detected by the detector system 15 and the results are analyzed by the intelligence system 14, any one of the components of the deter system 15 can be activated. For example, by broadcasting a customized, audible warning to anyone detected in the monitored zone (e.g., you are being watched and recorded), intruders are put on notice. Additionally, the present invention can include remote two-way conversation at the security site, which allows two-way conversation with a remote monitor and anyone detected in the monitored zone. Further, a strobe 210 or siren 211 can be activated. And still further, a spray emitter 216 can be activated to emit either an odor which may be offensive to humans or animals, or a dye can be emitted which can be readily seen in light or darkness, or may be detectable under an ultraviolet light.

The power system 12 can include, but is not limited to, a battery 11, an AC source 209, a thermal cell 215, a solar panel 212, a gas generator 214, or a wind generator 213. In a preferred embodiment, the security system 100 operates from the battery 11 which is recharged by any one of the listed power sources. Further, the battery 11 is preferably located in the weather proof control box 101. Additionally, the battery 11 can act as a backup power supply if a primary power supply (e.g., the AC source 209, the thermal cell 215, the solar panel 212, the gas generator 214, or the wind generator 213) is interrupted. Further, the tilt/tamper detector 16 could be arranged to detect interrupt of power supply and used to initiate deter measures and/or initiate communication of a security event.

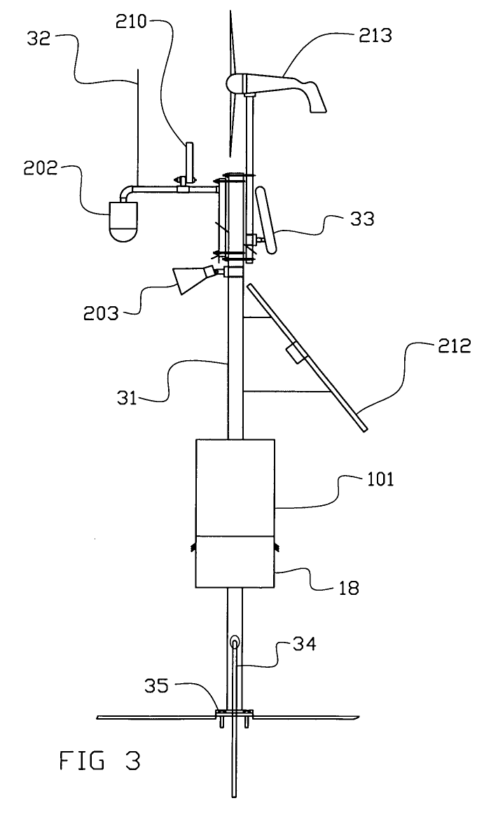

Now referring to FIG. 3, there is illustrated a mounting embodiment of the present invention. As shown, the control box 101, the detect components (as shown, for example, the video/camera 202 and other sensing devices 33), the deter components (as shown, for example, the two-way audio device 203), and the power components (as shown, for example, the solar panel 212 and the wind generator 213) are mounted to a ridged structure, such as a pole 31. As shown, the pole 31 is coupled to the ground 35, but the ridge structure could also be a mobile base which could be rolled into place. Also shown are an earth grounding rod 34 and an antenna for wireless communications. Additionally, the control box 101 and the other components could be mounted to separate ridge structures and/or mobile structures.

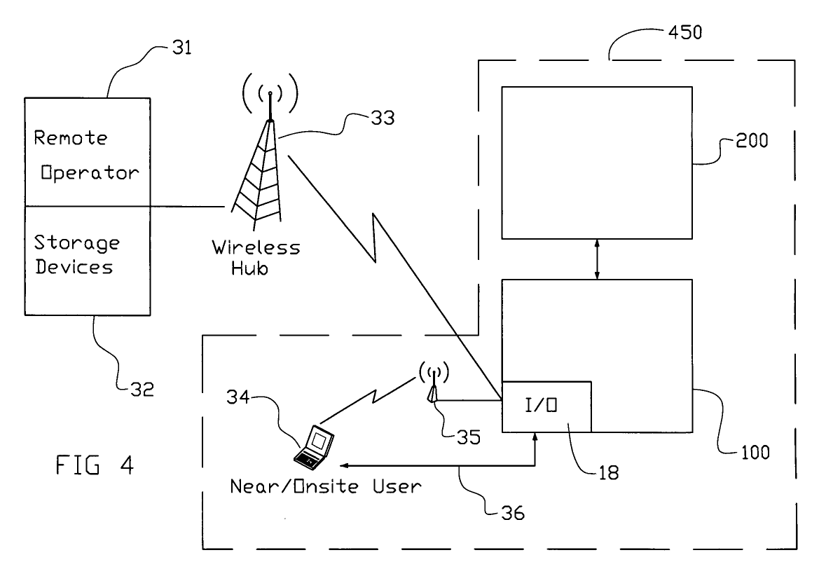

Now referring to FIG. 4 there is illustrated a security system in communication with near/onsite users and/or a remote operator in accordance with an embodiment of the present invention. The system 450 includes security system 100, security system 200, a near/onsite user 34, and a communication coupling from the security system 100 via the I/O 18 and the near/onsite user 34. The near/onsite user 34 communicates within system 450 via a computing device or a smart phone, though other types of communication devices are contemplated. The communication coupling can include a hard wire coupling 36 or a wireless coupling 35. The wireless coupling 35 can be a near range type wireless system such as the Bluetooth protocol, for example, though other types of wireless systems are contemplated.

The system 450 can also communicate to a remote operator 31 and a remote storage device 32 via a wireless communication system or wireless hub 33. The wireless communication system 33 can be, for example, a cellular network or wireless local area network although any other type wireless system may be used. Additionally, the remote operator 31 and/or the remote storage device 32 may be implemented as a server such as a web server, for example. The server can direct information from the remote operator 31 and/or the remote storage device 32 into an enterprise application. Additionally, the remote operator 31 and the remote storage devices may be located at the same site or different sites. Further, the remote operator 31 can include some or all of the embodiments above-described in the intelligence system 14 and the document memory system 17.

The remote operator 31 and the remote storage device 32 are configured to receive data of security events. As mentioned, the remote operator 31 can receive the data of security events and can also review the data and respond by activating some or all of the deter devices of the deter system 13. For example, the remote operator 31 can receive both video and sound from the detection devices of the detection system 15 and can analyze such, as the intelligence system 14 is capable of. Further, the remote storage device 32 is configured to store such data and can be stored on CD/DVD or other type storage devices known to those skilled in the art.

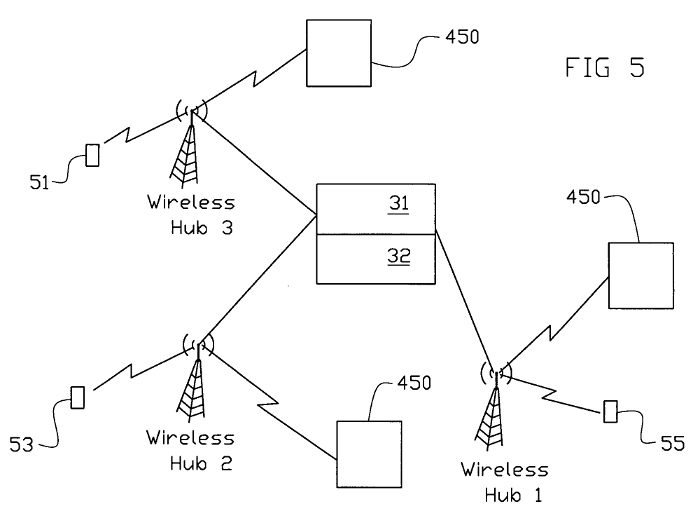

Now referring to FIG. 5 there is illustrated multiple security systems 450 in communication with to a remote operator 31 and remote storage devices 32 in accordance with an embodiment of the present invention. Each of the security systems 450 is configured to communicate to the remote operator 31 and remote storage devices 32 through a wireless hub. Each security system 450 can communicate through different wireless hubs or the same wireless hub to a single remote operator 31.

In another embodiment, the remote operator 31 is further configured to inform other remote operators 51, 53, 55 of security events via the wireless hubs. Messages from the remote operator 31 may be sent via email, text message, or phone call including an interactive voice response (IVR) system, for example. Further, the messages can include video and/or sound collected from the security system 200.

As mentioned, the remote operators 51, 53, 55 can be notified via the remote operator 31 of security events and, responsive thereto, the remote operators 51, 53, 55 are configurable to receive and review data of the security events and can remotely activate some or all of the deter devices of the deter system 13 and can remotely control the video device 202 of the security system 200 for panning the monitored area, in which control and communication is via the shown wireless systems. The remote operator 31 and the other remote operators 51, 53, 55 can also engage in two-way conversation with anyone in the secured area via the wireless hub system and the two-way audio device 203. Wherein, other remote operators 51, 53, 55 are assignable to a particular security system 450. So, for a first security system 450 monitoring a first area, only those other remote operators assigned to the first security system 450 are notified of security events in the first area and can activate deter devices in the first area.

The other remote operators can utilize portable personal digital assistants 51, a cellular telephone 53, personal computer 55, other computing devices know to those skilled in the are can also be used. Also, those skilled in the art should recognize that the access devices 51, 53, 55 can connect to and communicate with the security system of FIG. 5 in a variety of ways. The connection can be over the internet or through a wireless network such as a wireless local area network, a cellular wide area network, integrated WiFi, or over Bluetooth. The access devices can also connect directly to the security system 450 through an access point and can receive data directly from the input/output 18.

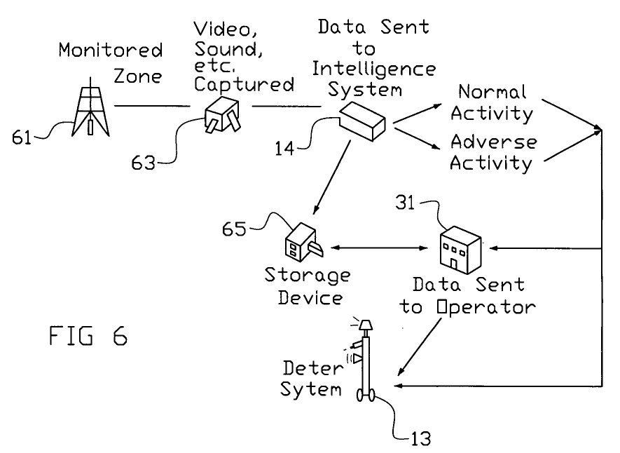

Now referring to FIG. 6 there is illustrated a methodology for monitoring a secured location in accordance with an embodiment of the present invention. Security events are monitored using one or more of the detectors sensory devices of the detector system 15 (shown in FIGS. 1 and 2) where video, sound, etc. from the secured location are captured. The captured data is transferred to the intelligence system 14. The Intelligence system 14 can include an object/image recognition system and a sound recognition system connectable with any of the sensory devices of the detector system 15.

The Intelligence system 14 is configured to recognize objects and sounds disposed around the monitored area (e.g., equipment, supplies, tools, and other objects meant to be monitored against theft and sabotage and sounds such as dogs, etc.) and objects that may enter the monitored area (e.g., people, animals, motorized vehicles, etc.). The Intelligence system 14 receives video from the video surveillance system 202 or sound system 203 and analyzes the video and sound to determine if an object has left, been moved from, or entered the monitored area. The object and sound recognition system of the Intelligence system 14 can compare data representative of the detected objects or sounds with data representative of known objects or sound. Thus, the intelligence system 14 can recognize normal and adverse activity. For example, the intelligence system 14 can determine objects in a first condition and further determine if there has been another condition in which the objects have been moved or removed from the monitor area or whether a human has entered the secured location. It further could determine if an object has entered the monitored area. Further, the intelligence system can determine if certain sounds are normal or indicate an adverse activity. In any case, the intelligence system 14 can initiate a deter measure using the deter system 13 if an adverse activity has been determined, and/or the intelligence system 14 may also initiate a communication with one or more operators 31, 51, 53, 55 which can also initiate a deter measure using the deter system 13.

Further, the intelligence system 14 and the operator 31 may transfer activity data to a storage device 65. The storage device 65 can be local to the intelligence system 14 or local to the operator 31. Transfer of data can be by any of the transmission types describe in previous paragraphs. If the activity or event has been captured on video, video data pertaining to the captured video may be stored in the storage device 65 and any one of the operators 31, 51, 53, 55 notified of an activity can access the storage device by use of a mobile device, for example. When the operators 31, 51, 53, 55 receives notification, they can acknowledge the activity, access stored activity and any video data stored, and can manipulate the video data such as by rewinding, forwarding, and other manipulation known to those skilled in the are. In another embodiment, video data can be streamed directly to the operators 31, 51, 53, 55.

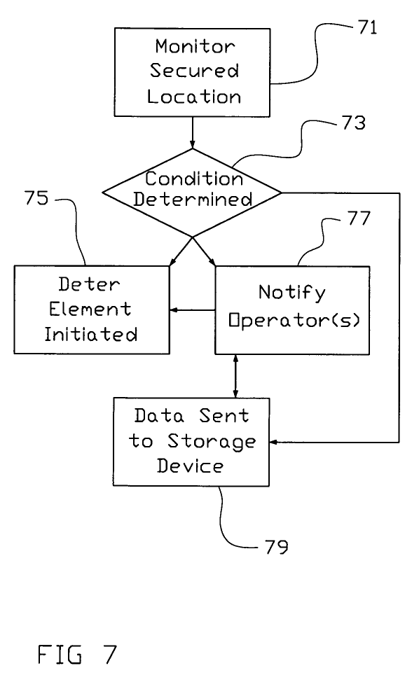

Now referring to FIG. 7 there is shown a method for monitoring a secured location in accordance with an embodiment of the present invention. With this embodiment, the first step is to monitor 71 a defined secured location. The defined secured location is preferably an outdoor location but could also be a large indoor location such as in an aircraft hanger. The next step is to determine 73 the conditions of the scanned secured location. In this embodiment, an intelligence system (described though out previous paragraphs of the Description) is configured to determine normal activities and adverse activities. Subsequently, on determination of the activities, a deter element can be initiated 75 for deterring determined adverse activity and/or an operator(s) can be notified 77 of the activities. In this embodiment, the notified operator(s) can also initiate one or more deter elements. Either from the condition determination 73 or from the notify operator steps, data of the determined activities can be transferred to a storage device 79. Further, the notified operator(s) can access data stored in the storage device 79.

Any embodiments of the method for detecting events at the secured location 71, determining normal and adverse activity 73, transferring data from of the activities, initiating deter measures 75, notifying operator(s) 77, and access to activity information stored in the storage device 79 can be implemented as a computer program used with a computer system in which a computer instructions embody all or parts of the functionality previously described with respect to the system and method. The computer instructions can be stored in any machine-readable medium. While a preferred computer instruction sequence can be determined by descriptions herein, it should be readily apparent to those skilled in the art that many variations in the sequence could be made to still achieve the same results.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for monitoring a secured location, the method comprising:
capturing events detected at the secured location by sensory devices;
receiving event data captured by the sensory devices;
identifying a first condition of the secured location in response to receiving events data captured by the sensory devices;
identifying a second condition of the secured location in response to receiving further event data capture by the sensory devices;
comparing the first and second conditions to determine if an abnormal condition exist; and
conditionally initiating a deter event local to the secured location responsive to a determined abnormal condition at the secured location.

2. The method of claim 1, wherein the initiating a deter event further including transceiving over a wireless communication system to an operator for supervising the secured location, the operator can determine if a deter event is to be initiated based on received conditions, wherein the deter event includes at least one of group comprising a two-way audio device, a strobe light, a siren, and a spray emitter.

3. The method of claim 1 further including transceiving determined conditions over a wireless communication system to an operator for supervising the secured location, the operator is a human receiving the determined conditions via a device configured to communicate on the wireless communication system, wherein the human operator determines whether a two-way audio communication at the secured location should be initiated based on the determined conditions.

4. The method of claim 1 further including transceiving determined conditions over a wireless communication system to an operator for supervising the secured location, wherein the operator is a computerized device configured to determine whether a deter device should be initiated based on received determined conditions, the determining condition step including recognizing conditions of objects within the secured location, wherein object recognition can determine the first condition of an object and the second condition of an object via a visual sensory device local to the secured location.

5. The method of claim 1 further including notifying other operators which are remote to the secured location via the wireless communication system responsive to a determined abnormal condition.

6. The method of claim 5, wherein the other remote operators are humans assigned to monitor events detected in the secured location.

7. The method of claim 6, wherein the human operators can initiate deter events local to the secured location.

8. The method of claim 1 further including transferring data indicative of the captured events detected at the secured location by sensory devices to a storage device.

9. The method of claim 8, wherein the storage device is local to the secured location.

10. The method of claim 8, wherein the storage device is remote to the secured location.

11. The method of claim 1 further comprising:
capturing events detected at another secured location by sensory devices;
receiving event data captured by the sensory devices of the another secured location;
identifying a first condition of the another secured location in response to receiving events data captured by the sensory devices;
identifying a second condition of the another secured location in response to receiving further event data capture by the sensory devices;
comparing the first and second conditions to determine if an abnormal condition exist at the another secured location; and
transmitting the determined conditions to a central operator for initiating a deter event at the respective secured locations responsive to a determined adverse condition.

12. The security system of claim 11 further including transmitting the event data captured by the respective sensory devices to a storage device.

13. The security system of claim 12, wherein the central operator can access the storage device to review the event data.

14. A method of monitoring events at a defined outdoor location, the outdoor location including a security event detection system which includes a video surveillance device configured to provide images of surrounding objects and further configurable to detect security events sensed from other sensing devices, the outdoor location also including deter devices, the deter devices including at least one of a plurality of devices selected from a group comprising a two-way audio device, a strobe light, a siren, and a spray emitter, and wherein the two-way audio device enables two-way conversation between an operator and anyone present in the outdoor location, the method comprising:
capturing events detected at the secured location by sensory devices;
identifying a first condition of the secured location in response to the captured detected events;
identifying a second condition of the secured location in response to receiving further captured events detected at the secured location;
comparing the first and second conditions to determine if an abnormal condition exist; and
notifying an operator for supervising the secured location responsive to a determined abnormal condition.

15. The method of claim 14, wherein the operator can initiate a deter event local to the secured location responsive to a determined abnormal condition.

16. The method of claim 14 further including transferring data indicative of the captured events detected at the secured location by sensory devices to a storage device.

17. The method of claim 16, wherein the storage device can be local to the outdoor location or remote to the outdoor location.

18. The method of claim 14 further including receiving object images and sensed security event data at a programmable determination device which can determine a first condition and a second condition of objects local to the outdoor location, the programmable determination device further determining if the abnormal condition exist and responsive to initiating a deter measure.

19. The method of claim 18, wherein the programmable determination device is capable of object condition recognition such that objects within the monitored outdoor area are first recorded in a first condition and a security event is initiated if any one of the objects are determined to be in a condition different from the first condition, wherein the conditions are provided via a further scan provided from the video surveillance device.

20. A machine-readable medium in which instructions thereon cause a computing device to perform a method of detecting and deterring defined activities at a secured location, the method comprising:
capturing events detected at the secured location by sensory devices;
receiving event data captured by the sensory devices;
identifying a first condition of the secured location in response to receiving events data captured by the sensory devices;
identifying a second condition of the secured location in response to receiving further event data capture by the sensory devices;
comparing the first and second conditions to determine if an abnormal condition exist; and
conditionally initiating a deter event local to the secured location responsive to a determined abnormal condition at the secured location.
